(19) United States
(12) Patent Application Publication
(10) Pub. No.: US 2025/0151724 A1
(43) Pub. Date: May 15, 2025

(54) Liquid Soil Treatments Containing Choline

(71) Applicant: Harrell's, LLC, Lakeland, FL (US)

(72) Inventors: Jeffrey L. Atkinson, Charlotte, NC (US); Raymond H. Snyder, Lakeland, FL (US)

(73) Assignee: Harrell's, LLC, Lakeland, FL (US)

(21) Appl. No.: 18/505,651

(22) Filed: Nov. 9, 2023

(51) Int. Cl. A01N 33/12; A01N 25/30

(52) U.S. Cl. CPC A01N 33/12; A01N 25/30

(57) ABSTRACT

The liquid soil treatments disclosed herein contain choline in amounts effective to prevent turf browning while complimenting the effects of a soil wetting agent on water movement. More specifically, the inclusion of certain amounts of choline with a soil wetting agent improved turf quality, turf color, photochemical efficiency, leaf chlorophyll content, leaf proline content, root surface area, root diameter, and root volume without significantly impacting the water content of the soil. Further, choline was demonstrated to enhance water penetration of a hydrophobic soil, absent of combination with a known soil wetting agent.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, LARGE TABLE, OR COMPUTER PROGRAM

Not Applicable

### FIELD OF THE INVENTION

The present invention relates to liquid soil treatment compositions. The compositions disclosed herein are useful in turfgrass management, agriculture, and ornamental production applications.

### BACKGROUND OF THE INVENTION

Wetting agents are used in a variety of applications to lower the surface tension of water to allow a solution to wet surfaces more effectively. Soil wetting agents are used extensively in turfgrass, agriculture, and ornamental production facilities for soil water management. In turfgrass management, agriculture, and ornamental production applications (e.g., golf courses, farms, nurseries, and greenhouses), soil wetting agents, also known as soil surfactants, are used to manage water repellency in soil to prevent or alleviate localized dry spots and to improve plant quality.

Relative to each other, some wetting agents function primarily as “distributors,” while some wetting agents act as “retainers.” Which function a wetting agent exhibits depends on how it is structured chemically. Specifically, in the case of ethylene oxide-propylene oxide (EO/PO) block copolymers, the hydrophilic ethylene oxide (EO) component is on the terminal ends of the molecule and the terminal ends are separated by a hydrophobic propylene oxide (PO) component. This molecular arrangement enhances water movement through hydrophobic soil particles and facilitates movement of excess water through the soil profile while retaining water around the particle through absorption. Alternatively, if the hydrophobic PO component is on the terminal ends of the molecule and the terminal ends are separated by a hydrophilic EO component, the chemistry will create pools of water between the soil particles, resulting in water retention. Environmental conditions, soil type, plant water requirement, and playability expectations influence practitioner wetting agent selection and use. In general, dryer soil conditions are linked to decreased disease pressures on the turf, which is considered advantageous from the perspective of reducing instances of disease in the turf. Diseased turf can cause several problems, including but not limited to expensive rehabilitation and/or replacement of the turf. Yet, dryer soil conditions are also linked with better turf conditions, for example, better conditions for playing golf on the surface of the turf.

As mentioned above, some wetting agents facilitate movement of excess water through the soil profile. Such wetting agents act as insurance against too much rainfall, as they will facilitate the movement of excess rainfall through the soil profile. However, in dry conditions, such as summer stress, these wetting agents are sometimes correlated with localized dry spots across a turfgrass sward. The corresponding decline in turf quality may require localized treatment, which is burdensome and expensive for turfgrass facility managers. In addition, localized variations in the turf and soil may cause moisture status to vary relatively widely within relatively small areas, also potentially resulting in localized dry spots. In either case, dry spots may cause the turf to brown, which is linked to increased physiological stresses on the turf and is considered generally undesirable and unsightly from a turf management perspective, particularly for sensitive surfaces such as golf course putting greens, tees, fairways, and sports fields.

Thus, there is a need in the art for a wetting agent that facilitates movement of excess water through the soil profile while also preventing browning of the turf.

### BRIEF SUMMARY OF THE INVENTION

Embodiments of the present invention address this need in the art for a liquid soil treatment that facilitates movement of excess water through the soil profile while also preventing browning of plants in the soil, such as turf. Choline is a compound associated with osmotic adjustment as the precursor of glycine betaine which is a significant osmoprotectant. The application of liquid soil treatments comprising choline to turf, such as creeping bentgrass, provides certain beneficial effects, such as improving turf quality and physiological fitness, particularly during summer stress conditions, among other advantages. Choline, however, exhibits an independent effect on the movement of water through the soil profile. The liquid soil treatments disclosed herein contain choline in amounts effective to prevent turf browning while complimenting the effects of the soil wetting agent on water movement. More specifically, the inclusion of certain amounts of choline, determined to have wetting agent properties of its own, with a soil wetting agent improved turf quality, turf color, photochemical efficiency, leaf chlorophyll content, leaf proline content, root surface area, root diameter, and root volume without significantly impacting the water content of the soil. Further, choline was demonstrated to enhance water penetration of a hydrophobic soil, absent of combination with a known soil wetting agent.

### BRIEF DESCRIPTION OF THE DRAWINGS

FIG. 1 includes a tabular listing of time to water drop penetration for distilled water control and various choline concentration solutions.

FIG. 2 is a photograph of samples at the end of the trial referred to herein as Experiment No. 4.

FIG. 3 is another photograph of samples at the end of the trial referred to herein as Experiment No. 4.

### DETAILED DESCRIPTION OF THE INVENTION

Exogenous application of certain small molecule organic compounds has been used to improve cool-season turfgrass quality as well as physiological fitness during summer stress as characterized by high temperature and drought conditions. Glycine betaine (GB) is one of the most important osmoprotectants. It can stabilize cell membranes and protect proteins, including photosystem II, and mitigate oxidative damage. Exogenous application of GB at proper rates has been shown to improve plant tolerance to abiotic stress such as heat, drought, and salt stress.

Choline is an important primary biochemical precursor of glycine betaine, and the physiological effects of applying choline to plants have been studied. Chemically, choline is a cation with the chemical formula [(CH₃)₃NCH₂CH₂OH]⁺. Choline forms various salts, for example, choline chloride and choline bitartrate. The effects of choline on soil wetting alone or when applied with a wetting agent, however, have not been appreciated or studied. Data was derived from a series of experiments in which varying amounts of choline were applied under test conditions, alone and in conjunction with various other substances, including soil wetting agents, to determine the effect, if any, on creeping bentgrass quality and physiological fitness under summer stress conditions. Through these experiments, as further described below, the inventors discovered that choline as a stand-alone material acts as a soil wetting agent and that the inclusion of unexpected amounts of choline in combination with a separate soil wetting agent promoted physiological fitness and visual quality of creeping bentgrass during heat and mild drought stress conditions while retaining the wetting agent properties of such separate wetting agent which without inclusion of choline would result in browning of the turf.

### Experiment No. 1

The inventors investigated whether foliar application of GB and choline, alone or

in combination, could improve creeping bentgrass quality and physiological fitness under heat and mild drought stress conditions.

### Materials and Methods

A growth chamber pot trial was conducted as follows. Creeping bentgrass—specifically, Memorial™ creeping bentgrass (Landmark Seed Company, Salem, Oregon)—was harvested from existing field plots and transplanted into 6-inch pots filled with fine sand and 10% peat, to be consistent with standards promulgated by the U.S. Golf Association (Bernards, New Jersey) for putting green soils. The bentgrass was maintained at 0.39″ (10 mm). The choline used in this study was supplied in the form of choline chloride from Sigma-Aldrich, Inc. (St. Louis, MO).

After 4 weeks of non-stressed growth with optimum temperature, water, fertilizer, and light, the pots were placed in a controlled environment growth chamber at 95° F. for 12 hours (day)/77° F. for 12 hours (night), light intensity was set at 400 μmol m⁻² s⁻¹, 12-hour photoperiod, and 60% relative humidity (RH). Water was replaced 6-7 times weekly at 40% of measured evapotranspiration (ET). These conditions simulated summer putting green stress.

The treatments were as follows:
1. Fertilized control (0.15 lb. Nitrogen (N) per 1,000 ft² every 14 days from 28-8-18 with UMAXX® fertilizer (Harrell's LLC, Lakeland, Florida).
2. GB at 0.5 oz./1,000 ft² every 14 days.
3. GB at 1.0 oz./1,000 ft² every 14 days.
4. Choline at 0.5 oz./1,000 ft² every 14 days.
5. Choline at 1.0 oz./1,000 ft² every 14 days.
6. GB at 0.5 oz./1,000 ft²+choline at 0.5 oz./1,000 ft² every 14 days.
7. GB at 1.0 oz./1,000 ft²+choline at 1.0 oz./1,000 ft² every 14 days.

The rate and source of fertilization for treatments #2-7 was the same as treatment #1 (fertilized control), so all seven treatments received identical fertility input. The stress period of the trial lasted for 8 weeks, with a total of 4 treatment applications. The term “low rate” is used in this description of Experiment No. 1 to refer to 0.5 oz./1,000 ft² treatments, while the term “high rate” is used to refer to 1.0 oz./1,000 ft² treatments.

The following measurements/data were taken at day 0, 14, 28, 42, and 56, or as otherwise indicated:
a. Visual leaf color was rated based on a visual scale of 1 through 9, with 1 indicating brown color and 9 indicating dark green color.
b. Photochemical efficiency (PE). Photochemical Efficiency was measured with a chlorophyll fluorometer (OS-50II, Opti-Sciences, Inc., Hudson, NH) biweekly based on the Fv/Fm, which is the ratio of variable chlorophyll fluorescence (Fv) to maximum chlorophyll fluorescence (Fm). Three readings were collected from each plot and the average was used for statistical analysis.
c. Clipping yield was taken with clipping back each specimen down to 10 mm and clippings collected.
d. Chlorophyll content. After clipping yields were weighed, leaf tissues were ground into powder, and chlorophyll was extracted in pure acetone content for 72 hours, and the absorbance was measured using a spectrophotometer.
e. Leaf carotenoids were extracted in the same sample as for chlorophyll content and carotenoids were measured using a spectrophotometer (Zhang et al., 2005).
f. Leaf proline content. Leaf tissue was ground into a powder with a mortar/pestle in liquid nitrogen, and proline was extracted in 3% sulfosalicylic acid. After centrifuging, the supernatant was collected, and proline was analyzed according to Wu et al., 2017.
g. Root viability. Fresh root samples were collected from each pot at the end of the trial, and TTC method was used to measure root viability as described in Zhang et al., 2017.
h. Root growth characteristics. At the end of trial, roots from each pot were washed and cleaned. Roots were scanned using WinRHIZO™ technology (Regent Instruments Inc., Quebec, Canada), and root length, root surface area, root diameter, and root volume were calculated. (Zhang et al., 2017).
i. Root biomass of each pot was determined at the end of the trial. Roots were dried at 65° C. for 72 hours before being weighed.

### Results & Discussion

Leaf color declined as heat and drought stress progressed. Application of choline at 0.5 oz. per 1,000 ft², choline at 1.0 oz. per 1,000 ft², and GB+choline (0.5 oz.+0.5 oz. per 1,000 ft²) consistently improved leaf color ratings (Table 1.1). Table 1.1 provides responses of leaf color, chlorophyll, carotenoids, and photochemical efficiency (PE, Fv/Fm) to foliar application of GB and choline in creeping bentgrass subjected to heat and mild drought stress, as measured on the day indicated.

TABLE 1.1
Creeping Bentgrass Leaf Color, Chlorophyll Content, Carotenoids
Content, and Photochemical Efficiency in response to foliar application
of GB and choline under heat and mild drought stress.

| | Rate (oz/ | -------------- days after treatment initiation -------------- | | | | |
|---|---|---|---|---|---|---|
| Treatment | 1000 ft²) | 0 | 14 | 28 | 42 | 56 |
| | | Leaf color (1-9, 9 = dark green) | | | | |
| Control | — | 7.5a | 7.0c | 6.4b | 6.8ab | 6.1c |
| GB | 0.5 | 7.5a | 7.1bc | 6.3b | 6.9ab | 6.3bc |
| GB | 1.0 | 7.5a | 7.3abc | 7.0a | 6.5b | 6.4abc |
| Choline | 0.5 | 7.5a | 7.3abc | 6.9a | 7.1a | 7.0a |
| Choline | 1.0 | 7.5a | 7.5a | 7.3a | 7.1a | 7.0a |
| GB + Choline | 0.5 + 0.5 | 7.5a | 7.5a | 7.1a | 7.0a | 7.0a |
| GB + Choline | 1.0 + 1.0 | 7.5a | 7.4ab | 7.1a | 6.9ab | 6.9ab |
| | | Chlorophyll (mg/g FW) | | | | |
| Control | 0 | 3.45a | 3.44a | 2.46c | 1.95b | 2.25c |
| GB | 0.5 | 3.43a | 3.44a | 2.89abc | 2.80ab | 2.63abc |
| GB | 1.0 | 3.42a | 3.43a | 2.71bc | 2.47ab | 2.55bc |
| Choline | 0.5 | 3.50a | 3.51a | 3.09ab | 2.76ab | 2.98a |
| Choline | 1.0 | 3.46a | 3.51a | 3.31a | 2.93a | 2.75ab |
| GB + Choline | 0.5 + 0.5 | 3.43a | 3.53a | 2.83abc | 3.09a | 2.86ab |
| GB + Choline | 1.0 + 1.0 | 3.45a | 3.54a | 3.01ab | 3.28a | 2.77ab |
| | | Carotenoids (mg/g FW) | | | | |
| Control | 0 | 1.32a | 1.31a | 1.01b | 0.78b | 0.88b |
| GB | 0.5 | 1.31a | 1.31a | 1.00ab | 1.13a | 1.08ab |
| GB | 1.0 | 1.30a | 1.31a | 1.02b | 0.99ab | 0.96ab |
| Choline | 0.5 | 1.32a | 1.32a | 1.18ab | 1.12a | 1.12a |
| Choline | 1.0 | 1.31a | 1.33a | 1.23a | 1.17a | 1.06a |
| GB + Choline | 0.5 + 0.5 | 1.31a | 1.31a | 1.08ab | 1.22a | 1.08ab |
| GB + Choline | 1.0 + 1.0 | 1.32a | 1.34a | 1.14ab | 1.27a | 1.07a |
| | | PE (Fᵥ/Fₘ) | | | | |
| Control | 0 | 0.765a | 0.709b | 0.656b | 0.641ab | 0.619b |
| GB | 0.5 | 0.777a | 0.744ab | 0.676ab | 0.668ab | 0.646ab |
| GB | 1.0 | 0.743a | 0.765a | 0.715ab | 0.673ab | 0.651a |
| Choline | 0.5 | 0.763a | 0.751a | 0.676ab | 0.631b | 0.649a |
| Choline | 1.0 | 0.777a | 0.738ab | 0.718ab | 0.683ab | 0.664a |
| GB + Choline | 0.5 + 0.5 | 0.756a | 0.743ab | 0.707ab | 0.703a | 0.645ab |
| GB + Choline | 1.0 + 1.0 | 0.761a | 0.745ab | 0.736a | 0.690ab | 0.653a |

Means followed by the same letter(s) within the same column for each data set are not significantly different at P = 0.05. The letters connote the same meaning in the other tables herein.

Choline at both rates, and choline plus GB, improved chlorophyll content as measured at day 56 (Table 1.1). Specifically, choline at 0.5 oz., choline at 1.0 oz., GB+choline (0.5+0.5 oz.), and GB+choline (1.0+1.0 oz.) increased chlorophyll content by 32.4%, 22.2%, 27.1%, and 23.1%, respectively.

Carotenoids are pigments that protect chlorophyll molecules as antioxidants under stress. Heat and mild drought stress generally reduce carotenoids, and application of choline and GB+choline alleviated carotenoids decline as measured at day 42 and 56 except for GB+choline at low rate. (Table 1.1).

Photochemical efficiency (PE) is a good indicator of photosynthetic function. Application of GB at 1.0 oz., choline at 0.5 oz., choline at 1.0 oz., and GB+choline (1.0+1.0 oz.) increased PE at day 56 (Table 1.1). GB+choline (0.5+0.5 oz.) also improved PE as measured at day 42.

Proline is an important osmoprotectant. All treatments except for low rate GB (0.5 oz.) improved leaf proline content (Table 1.2). GB+choline (1.0+1.0 oz.) also improved proline content at day 28 and day 42. Table 1.2 provides leaf proline responses to foliar application of glycine betaine (GB) and choline in creeping bentgrass subjected to heat and mild drought stress.

TABLE 1.2
Creeping Bentgrass Proline Concentration Response to Foliar Application of
Glycine Betaine and Choline when Grown Under Heat and Mild Drought Stress

| | | Proline (mg/g FW) | | | | |
|---|---|---|---|---|---|---|
| | Rate (oz/ | -------------- days after treatment initiation -------------- | | | | |
| Treatment | 1000 ft²) | 0 | 14 | 28 | 42 | 56 |
| Control | 0 | 18.9a | 19.9c | 21.3b | 29.0c | 36.1b |
| GB | 0.5 | 19.0a | 21.2bc | 35.1a | 34.9bc | 62.9ab |
| GB | 1.0 | 18.6a | 21.6bc | 25.8b | 38.9abc | 68.5a |
| Choline | 0.5 | 20.1a | 46.1a | 24.3b | 30.2c | 79.6a |
| Choline | 1.0 | 19.8a | 43.5ab | 24.6b | 43.8ab | 67.6a |
| GB + Choline | 0.5 + 0.5 | 19.3a | 24.4abc | 25.2b | 37.5bc | 68.6a |
| GB + Choline | 1.0 + 1.0 | 20.1a | 19.6c | 35.9a | 48.0a | 67.0a |

The treatments did not increase clipping production (Table 1.3), suggesting that application of the two compounds will not increase mowing frequency in turf management. Table 1.3 provides clipping responses to foliar application of glycine betaine (GB) and choline in creeping bentgrass subjected to heat and mild drought stress.

TABLE 1.3
Creeping Bentgrass Clipping Yield Response to Foliar Application of Glycine
Betaine and Choline when Grown Under Heat and Mild Drought Stress

| | | Clippings dry wt (g/pot) | | | | |
|---|---|---|---|---|---|---|
| | Rate (oz/ | -------------- days after treatment initiation -------------- | | | | |
| Treatment | 1000 ft²) | 14 | 28 | 42 | 56 | Total |
| Control | 0 | 0.154ab | 0.176ab | 0.194a | 0.243ab | 0.767abc |
| GB | 0.5 | 0.159ab | 0.143b | 0.152a | 0.233ab | 0.686bc |
| GB | 1.0 | 0.211a | 0.225a | 0.189a | 0.252a | 0.876a |
| Choline | 0.5 | 0.149b | 0.151b | 0.159a | 0.233ab | 0.691bc |
| Choline | 1.0 | 0.187ab | 0.183ab | 0.223a | 0.249a | 0.842ab |
| GB + Choline | 0.5 + 0.5 | 0.138b | 0.166ab | 0.217a | 0.242ab | 0.762abc |
| GB + Choline | 1.0 + 1.0 | 0.192ab | 0.174ab | 0.139a | 0.146b | 0.650c |

Application of GB and choline, alone or in combination, tended to increase root biomass, and GB+choline (0.5+0.5 oz.) significantly increased root biomass (Table 1.4.1). GB+choline (0.5+0.5 oz.) also increased root length and root surface area (Table 1.4.1). GB+choline (0.5+0.5 oz.) increased root biomass, root length, and root surface area by 37.4%, 42.6%, and 37.6%, respectively (Table 1.4.1). Table 1.4.1 provides root biomass, root length, and surface area (SA) responses to foliar application of glycine betaine (GB) and choline in creeping bentgrass subjected to heat and mild drought stress.

TABLE 1.4.1
Creeping Bentgrass Root Biomass, Length, and Surface Area
Response to Foliar Applications of Glycine Betaine and
Choline when Grown Under Heat and Mild Drought Stress

| | Rate | Biomass | Length | SA |
|---|---|---|---|---|
| Treatment | (oz/1000 ft²) | (g/pot) | (mm/cm³) | (cm³/cm³) |
| Control | 0 | 1.39b | 33.1b | 2.02b |
| GB | 0.5 | 1.34b | 33.1b | 1.99b |
| GB | 1 | 1.64ab | 40.3ab | 2.21ab |
| Choline | 0.5 | 1.72ab | 39.7ab | 2.40ab |
| Choline | 1 | 1.57ab | 39.0ab | 2.32ab |
| GB + Choline | 0.5 + 0.5 | 1.91a | 47.2a | 2.78a |
| GB + Choline | 1.0 + 1.0 | 1.68ab | 41.3ab | 2.48ab |

GB and choline treatments did not impact root diameter and root volume (Table 1.4.2). Table 1.4.2 provides diameter, root volume, and root viability responses to foliar application of glycine betaine (GB) and choline in creeping bentgrass subjected to heat and mild drought stress.

TABLE 1.4.2
Creeping Bentgrass Root Diameter, Volume, and Viability
Response to Foliar Applications of Glycine Betaine and
Choline when Grown Under Heat and Mild Drought Stress

| | Rate | Diameter | Volume | Viability |
|---|---|---|---|---|
| Treatment | (oz/1000 ft²) | (mm) | (dm³/cm³) | (A490/g FW) |
| Control | 0 | 0.193a | 9.9a | 0.528d |
| GB | 0.5 | 0.189ab | 9.6a | 0.877abcd |
| GB | 1 | 0.174b | 9.7a | 1.076ab |
| Choline | 0.5 | 0.192a | 11.6a | 0.739bcd |
| Choline | 1 | 0.192a | 11.0a | 1.019abc |
| GB + Choline | 0.5 + 0.5 | 0.189ab | 13.2a | 0.699cd |
| GB + Choline | 1.0 + 1.0 | 0.193a | 11.9a | 1.207a |

Root viability is a good indicator of root function associated with water and nutrient uptake and use efficiency. GB at 1.0 oz., choline at 1.0 oz., and their combination (1.0+1.0 oz.) increased root viability (Table 1.4.2).

In summary, foliar application of choline, alone or in combination with GB, improved leaf color, chlorophyll, carotenoids, photochemical efficiency, and proline content of creeping bentgrass under heat and mild drought stress conditions. Foliar application of GB+choline at low rate consistently improved root biomass, root length, and root surface area. Overall, choline alone or low rate plus low-rate GB exhibited the greatest beneficial effects on physiological fitness and visual quality of creeping bentgrass during heat and mild drought stress conditions. The results of this study suggest foliar application of choline with or without GB biweekly may improve creeping bentgrass quality during summer stress.

### Experiment No. 2

Managers of turfgrass facilities rely on wetting agent treatments to optimize soil moisture volume and consistency. Modifications to such treatments may impact the movement of water through the soil, causing water to accumulate or deplete more rapidly than desired. Moreover, modifying the amount or timing of wetting agent applications is potentially disruptive to the management of such facilities. The inventors thus investigated whether, and to what extent, if any, the application of choline to turf affected the movement of water through the soil profile.

### Materials and Methods

The study was carried out on a creeping bentgrass putting green. There were two separate trials (Trial 1 and Trial 2). Trial 1 and Trial 2 were conducted side by side. Each trial consisted of 2 treatments with 4 replications. Plot size was 5×6 ft. Regular mowing and irrigation were performed. A randomized block design was used.

The treatments were as follows:
I. Choline Trial 1-Biweekly
   1. Fertilized Control
   2. Choline 0.5 oz./1,000 ft² every two weeks
II. Choline Trial 2-Monthly
   1. Fertilized Control
   2. Choline 0.5 oz./1,000 ft² every month

Between 0.125″ and 0.25″ of irrigation was applied 3-4 hours post application. All treatments received equal fertility (applied bi-weekly) with 28-8-18 with UMAXX® fertilizer (Harrell's, Lakeland, Florida) applied on the day following application of treatments.

The trials lasted for 15 weeks and a total of 7 treatment applications in the bi-weekly trial and 4 treatment applications in the monthly trial. The following measurements data were taken at the specified intervals throughout the trials:
a. Volumetric water content (VWC) was measured with a TDR350 moisture sensor (Turf-Tec Intentional, Tallahassee, FL) every 2 weeks. In addition, beginning on days 13, 34, and 69, irrigation was withheld for about 9 days to allow gradual decline of the soil water content, inducing significant decline in leaf color and turf quality. Volumetric water content was measured at day 0 (the day of initiation of irrigation withholding), day 3, day 6, and day 9. Irrigation was resumed after day 9 of the first and second dry down cycle. Irrigation was resumed after day 6 of the third dry down cycle because the plots dried down faster than expected. Three readings of VWC were collected from each plot and the average was used for statistical analysis.
b. Leaf color was rated based on a visual scale of 1 through 9, with 1 indicating brown color and 9 indicating dark green color.
c. Turf quality was rated based on a visual scale of 1 through 9, with 9 indicating the best quality and 6 indicating the minimum commercially acceptable quality.

### Results & Discussion

### Trial 1-Biweekly

Soil volumetric water content. During the 2^{nd} dry down cycle the choline treatment had higher VWC relative to the control as measured on day 38. During the 3rd dry-down cycle, the choline treatment had higher VWC relative to the control as measured on days 71 and 76 (Table 2.1). Table 2.1 provides volumetric water content responses to choline applied biweekly to a creeping bentgrass putting green during summer months, for Trial 1.

TABLE 2.1
Soil Volumetric Water Content Response to Choline Applied Biweekly
to a Creeping Bentgrass Putting Green During Summer Months

| | | VWC (%) | | | | | |
|---|---|---|---|---|---|---|---|
| | Rate (oz/ | -------------- days after treatment initiation -------------- | | | | | |
| Treatment | 1000 ft²) | 0 | 14 | 17 | 20 | 22 | 29 |
| 1. Control | 0 | 28.8a | 25.2a | 26.3a | 20.9a | 15.0a | 23.2a |
| 2. Choline | 0.5 | 23.7a | 26.3a | 23.8a | 22.6a | 16.6a | 22.1a |
| | | -------------- days after treatment initiation -------------- | | | | | |
| | | 34 | 38 | 41 | 43 | 57 | 71 |
| 1. Control | 0 | 26.4a | 19.6b | 16.2a | 13.4a | 16.5a | 11.8b |
| 2. Choline | 0.5 | 22.7a | 25.7a | 17.2a | 14.6a | 19.7a | 24.5a |
| | | -------------- days after treatment initiation -------------- | | | | | |
| | | 76 | 78 | 84 | 98 | | |
| 1. Control | 0 | 10.3b | 9.5a | 23.5a | 24.7a | | |
| 2. Choline | 0.5 | 17.6a | 12.8a | 24.7a | 25.9a | | |

Turf Quality and Turf Color. The choline treatments consistently improved turf quality and color beginning during the 1^{st} dry down cycle and continuing through the remainder of the trial. Turf quality and color can serve as a visual indicator of soil volumetric water content. Under drought conditions, i.e., low soil VWC, turf quality and color generally decline. Application of choline at 0.5 oz/1000 ft² limited the reduction in turf quality and color under drought conditions compared to the control. Table 2.2 and 2.3 provide turf quality and color responses to choline in creeping bentgrass putting greens during summer months, for Trial 1.

TABLE 2.2
Turf Quality Response to Choline Applied Biweekly to a
Creeping Bentgrass Putting Green During Summer Months

| | | Turf quality (1-9, 9 = best) | | | | | |
|---|---|---|---|---|---|---|---|
| | Rate oz/ | -------------- days after treatment initiation -------------- | | | | | |
| Treatment | 1000 ft² | 0 | 14 | 17 | 20 | 22 | 29 |
| 1. Control | 0 | 7.0a | 7.0a | 6.9a | 6.4b | 6.1b | 5.8b |
| 2. Choline | 0.5 | 6.9a | 7.1a | 7.0a | 7.0a | 7.0a | 7.0a |
| | | -------------- days after treatment initiation -------------- | | | | | |
| | | 34 | 38 | 41 | 43 | 57 | 71 |
| 1. Control | 0 | 6.4b | 6.4b | 6.4b | 5.6b | 3.6b | 3.4b |
| 2. Choline | 0.5 | 6.9a | 7.1a | 7.0a | 6.5a | 5.9a | 6.1a |
| | | -------------- days after treatment initiation -------------- | | | | | |
| | | 76 | 78 | 84 | 98 | | |
| 1. Control | 0 | 4.1b | 2.6b | 3.0b | 3.1b | | |
| 2. Choline | 0.5 | 6.0a | 5.6a | 5.8a | 6.1a | | |

TABLE 2.3
Turf Color Response to Choline Applied Biweekly to a
Creeping Bentgrass Putting Green During Summer Months

| | | Leaf color (1-9, 9 = dark green) | | | | | |
|---|---|---|---|---|---|---|---|
| | Rate oz/ | -------------- days after treatment initiation -------------- | | | | | |
| Treatment | 1000 ft² | 0 | 14 | 17 | 20 | 22 | 29 |
| 1. Control | 0 | 7.0a | 7.0a | 7.0a | 6.6b | 6.5b | 6.5b |
| 2. Choline | 0.5 | 7.0a | 7.0a | 7.0a | 7.0a | 6.9a | 7.0a |
| | | -------------- days after treatment initiation -------------- | | | | | |
| | | 34 | 38 | 41 | 43 | 57 | 71 |
| 1. Control | 0 | 6.9b | 6.9b | 6.8b | 5.8b | 4.9b | 4.4b |
| 2. Choline | 0.5 | 7.4a | 7.5a | 7.4a | 7.1a | 6.5a | 6.4a |
| | | -------------- days after treatment initiation -------------- | | | | | |
| | | 76 | 78 | 84 | 98 | | |
| 1. Control | 0 | 5.1b | 3.9b | 4.1b | 4.3b | | |
| 2. Choline | 0.5 | 6.5a | 6.4a | 6.8a | 7.0a | | |

### Trial 2—Monthly

The choline treatments tended to have higher soil VWC than the control through the duration of the trial (Table 2.4). Choline treatment significantly increased VWC relative to the control at the end of 2^{nd} and 3^{rd} dry-down cycles on days 43, 76, and 78. Table 2.4 provides volumetric water content responses to choline in creeping bentgrass.

TABLE 2.4
Soil Volumetric Water Content Response to Choline Applied Monthly
to a Creeping Bentgrass Putting Green During Summer Months

| | | VWC (%) | | | | | |
|---|---|---|---|---|---|---|---|
| | Rate oz/ | -------------- days after treatment initiation -------------- | | | | | |
| Treatment | 1000 ft² | 0 | 14 | 17 | 20 | 22 | 29 |
| 1. Control | 0 | 29.5a | 28.0a | 28.2a | 22.7a | 17.9a | 23.1a |
| 2. Choline | 0.5 | 34.1a | 32.6a | 32.5a | 28.9a | 25.2a | 28.3a |
| | | -------------- days after treatment initiation -------------- | | | | | |
| | | 34 | 38 | 41 | 43 | 57 | 71 |
| 1. Control | 0 | 26.2a | 23.2a | 17.1a | 12.3b | 28.0a | 22.9a |
| 2. Choline | 0.5 | 31.0a | 30.1a | 24.7a | 23.8a | 29.1a | 32.1a |
| | | -------------- days after treatment initiation -------------- | | | | | |
| | | 76 | 78 | 84 | 98 | | |
| 1. Control | 0 | 12.0b | 11.1b | 24.2a | 22.9a | | |
| 2. Choline | 0.5 | 28.6a | 25.0a | 32.6a | 31.2a | | |

Turf Quality and Turf Color. The choline treatments consistently improved turf quality and color beginning during the 1^{st} dry down cycle and continuing through the remainder of the trial. Turf quality and color can serve as a visual indicator of soil volumetric water content. Under drought conditions turf quality and color generally decline. Application of choline at 0.5 oz/1000 ft² limited the reduction in turf quality and color under drought conditions compared to the control. Table 2.5 and 2.6 provides turf quality and color responses to choline in creeping bentgrass putting greens during summer months, for Trial 2.

TABLE 2.5
Turf Quality Response to Choline Applied Monthly to a
Creeping Bentgrass Putting Green During Summer Months

| | | Turf Quality (1-9, 9 = best) | | | | | |
|---|---|---|---|---|---|---|---|
| | Rate oz/ | -------------- days after treatment initiation -------------- | | | | | |
| Treatment | 1000 ft² | 0 | 14 | 17 | 20 | 22 | 29 |
| 1. Control | 0 | 7.0a | 7.0a | 6.9a | 6.8b | 6.1a | 5.9b |
| 2. Choline | 0.5 | 7.0a | 6.9a | 7.0a | 7.3a | 6.6a | 6.6a |
| | | -------------- days after treatment initiation -------------- | | | | | |
| | | 34 | 38 | 41 | 43 | 57 | 71 |
| 1. Control | 0 | 6.6b | 6.4b | 6.3b | 5.8b | 4.8b | 5.3b |
| 2. Choline | 0.5 | 7.3a | 7.0a | 7.0a | 6.6a | 6.8a | 6.8a |
| | | -------------- days after treatment initiation -------------- | | | | | |
| | | 76 | 78 | 84 | 98 | | |
| 1. Control | 0 | 5.0b | 4.0b | 4.3b | 4.8b | | |
| 2. Choline | 0.5 | 6.6a | 6.5a | 7.0a | 7.3a | | |

TABLE 2.6
Leaf Color Response to Choline Applied Monthly to a
Creeping Bentgrass Putting Green During Summer Months

| | | Leaf Color (1-9, 9 = dark green) | | | | | |
|---|---|---|---|---|---|---|---|
| | Rate oz/ | -------------- days after treatment initiation -------------- | | | | | |
| Treatment | 1000 ft² | 0 | 14 | 17 | 20 | 22 | 29 |
| 1. Control | 0 | 7.0a | 7.0a | 7.0a | 6.4b | 6.4a | 6.4b |
| 2. Choline | 0.5 | 7.0a | 6.9a | 7.0a | 7.0a | 6.9a | 7.0a |
| | | -------------- days after treatment initiation -------------- | | | | | |
| | | 34 | 38 | 41 | 43 | 57 | 71 |
| 1. Control | 0 | 7.0b | 6.6b | 6.9b | 5.9b | 5.4b | 5.8b |
| 2. Choline | 0.5 | 7.5a | 7.1a | 7.5a | 6.9a | 7.1a | 6.9a |
| | | -------------- days after treatment initiation -------------- | | | | | |
| | | 76 | 78 | 84 | 98 | | |
| 1. Control | 0 | 6.1b | 5.0b | 5.3b | 5.5b | | |
| 2. Choline | 0.5 | 7.0a | 7.0a | 7.3a | 7.7a | | |

In summary, in both trials, choline treatments tended to maintain higher soil water content, turf color, and turf quality than the control, suggesting that the choline treatments were impacting the movement of water through the soil.

### Experiment No. 3

Previous testing results showed that choline at 0.5 oz/1000 ft² applied alone exhibited significant beneficial effects on soil moisture status, turf quality and turf color, especially during dry-down periods when soil water was limited. However, no research was reported on the possible function of choline as a surfactant or an enhancer of water penetration, or the optimum rate of choline for improving water penetration. The next experiment evaluated the effects of choline at four different rates on water penetration on growth media of creeping bentgrass putting greens.

### Materials and Methods

Soil cores (1 inch diameter and 6 inches deep) were taken from a creeping bentgrass putting green and dried at 65° C. for 48 hours then allowed to air dry for 2 days. Water drop penetration was tested 2 days after oven drying, and it was found that the choline treatments reduced the time of water drop penetration, but the time that the water drops stayed on the sand media was not long enough to quantify separations among the treatments due to inadequate water repellency of the sand media. The soil cores were allowed to air dry for additional 4 days and the water drop penetration test was repeated using the same method. The four treatments were 1) control (distilled water), 2) distilled water plus choline at 0.125 oz./1,000 ft², 3) distilled water plus choline at 0.25 oz./1,000 ft², and 4) distilled water plus choline at 0.5 oz./1,000 ft². There were 3 replications for each treatment. The water drops from distilled water or choline solution were placed on soil cores 0.75 inch from the soil surface. As soon as the water drops reached the soil, a timer was started. When each water drop had disappeared and the water had penetrated into the soil, the time elapsed was recorded.

### Results and Discussion

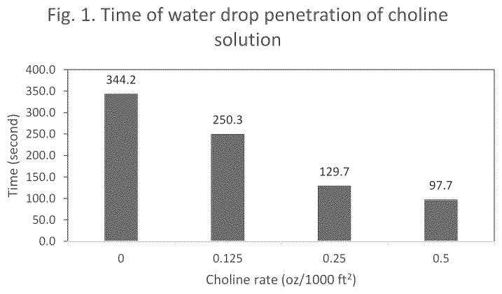

The results showed that choline treatment at 0.5 oz./1,000 ft² significantly improved water penetration. Choline at lower rates (0.25 and 0.125 oz./1,000 ft²) tended to reduce water drop penetration time, although not statistically significant at 5% probability level (Table 3.1). On average, it took 344.2 seconds for distilled water to penetrate the sand media, 250.3 seconds for choline solution at 0.125 oz./1,000 ft² to penetrate the sand media, 129.7 seconds for choline solution at 0.25 oz./1,000 ft², and 97.7 seconds for choline solution at 0.5 oz./1,000 ft² to penetrate sand media (Table 3.1, FIG. 1). Table 3.1 provides water drop penetration time (in seconds) of different choline rates for each of the 3 replications for each treatment.

TABLE 3.1
Water Drop Penetration Time of Different Coline Rates

| Choline Rate | Time of water drop penetration (seconds) | | | |
|---|---|---|---|---|
| (oz/1000 ft2) | Rep I | Rep II | Rep III | Average |
| 0 - distilled water | 588 | 187 | 258 | 344.2a |
| 0.125 | 454 | 106 | 191 | 250.3ab |
| 0.25 | 110 | 72 | 207 | 129.7ab |
| 0.5 | 97 | 26 | 170 | 97.7b |

Water drop penetration time was 2.5-fold shorter with choline solution treatment at 0.5 oz./1,000 ft² relative to the control (distilled water). The result of this testing surprisingly suggests that choline does not only improve osmotic adjustment by functioning as a biochemical precursor of glycine betaine but also reduces water repellency and improves water penetration in hydrophobic soil, resulting in mitigation of turfgrass drought stress.

### Experiment No. 4

The prior experiments showed that exogenous application of choline improved creeping bentgrass drought and heat tolerance. The objective of this experiment was to evaluate effects of choline at different rates not previously explored on physiological fitness and quality of creeping bentgrass subjected to heat and drought stress conditions.

### Materials and Methods

Mature ‘A4’ creeping bentgrass plugs (4″ diameter) were harvested from field plots and transplanted into 6-inch pots filled with a USGA (United States Golf Association) specification sand mix (fine sand with 10% calcined clay). The bentgrass was maintained at 15 mm and fertilized at 0.2 lb N/1,000 ft² at transplanting and then 0.15 lb N/1,000 ft² biweekly thereafter. After about 2 months of non-stressed growth with optimum temperature, water, fertilizer, and light, the pots were placed in a controlled environment growth chamber at 95° F. day (12 h)/77° F. night (12 h), light intensity at 400 μmol m⁻² s⁻¹, 12 h photoperiod, and 65% RH. Water was replaced 5 times weekly at 55% of measured evapotranspiration (ET). These conditions simulated summer putting green stress. Four treatments were tested with 4 replications for each treatment. The choline chloride solution at the 4 rates listed below was applied to the canopy at 2 gallons/1,000 ft² and the same amount of water was applied to the control (Treatment #1).

The treatments were as follows:
1. Fertilized control (0.15 lb. Nitrogen (N) per 1,000 ft² every 14 days from 28-8-18 with UMAXX® fertilizer (Harrell's LLC, Lakeland, Florida)
2. Choline at 0.125 oz./1,000 ft² biweekly+0.15 lb. N/1,000 ft² biweekly
3. Choline at 0.25 oz./1,000 ft² biweekly+0.15 lb. N/1,000 ft² biweekly
4. Choline at 0.5 oz./1,000 ft² biweekly+0.15 lb. N/1,000 ft² biweekly
   The rate and source of fertilization for treatments #2, 3, and 4 were the same as treatment #1 (fertilized control).

The stress period of the trial lasted for 8 weeks, and there was a total of 4 treatment applications. The following measurements/data were taken at day 0, 14, 28, 42, and 56:
a. Visual leaf color was rated on a 1-9 scale, with 1 indicating brown color and 9 indicating dark green color.
b. Photochemical efficiency was measured with chlorophyll fluorometer (OS-50II, Opti-Sciences, Inc., Hudson, NH). Three readings were collected from each pot and the average was used for statistical analysis.
c. Leaf chlorophyll content and carotenoids were extracted in acetone and measured with a spectrophotometer after incubation for 72 h.
d. Leaf proline content was determined based on the method of Bates et al. 1973 and as described by Wu et al. 2017.
e. Leaf antioxidant superoxide dismutase (SOD) activity was determined based on the method as described by Zhang et al. 2015.
f. Root viability, root samples were collected at the end of the trial and TTC method was used to measure root viability as described by Zhang et al., 2017.
g. Root growth characteristics (root length, root surface area, root diameter, root length density) were determined using WinRHIZO technology.
h. Root biomass of the whole pot was measured at day 56.
   For leaf chlorophyll, carotenoids, proline, and superoxide dismutase (SOD) activity, fresh samples were collected every two weeks and frozen with liquid and stored at −80° C. before lab analysis.

### Results and Discussion

Leaf color and photochemical efficiency (PE). Foliar application of choline at 0.25 and 0.5 oz./1,000 ft² improved leaf color ratings as measured at day 14, day 28, day 42, and day 56 (Table 4.1). Low rate of choline (0.125 oz./1,000 ft²) did not impact leaf color ratings. Choline applied at 0.25 and 0.5 oz./1,000 ft² improved PE as measured at day 42 and day 56 (Table 4.1). Choline applied at 0.125 oz/1000 ft² did not affect leaf color or PE compared to the control.

Table 4.1 provides leaf color and photochemical efficiency (PE) responses to foliar application of choline in creeping bentgrass subjected to heat and drought stress.

TABLE 4.1
Leaf Color and Photochemical Efficiency Responses to Foliar Application
of Choline in Creeping Bentgrass Subjected to Heat and Drought Stress

| | Rate oz/ | -------------- days after treatment initiation -------------- | | | | |
|---|---|---|---|---|---|---|
| Treatment | 1000 ft² | 0 | 14 | 28 | 42 | 56 |
| | | Leaf color (1-9, 9 = dark green) | | | | |
| Control | 0 | 8.0a | 7.0b | 5.9b | 6.1b | 5.9b |
| Choline | 0.125 | 8.0a | 7.1ab | 6.0b | 6.3b | 6.0b |
| Choline | 0.25 | 8.0a | 7.4a | 6.6a | 6.7a | 6.6a |
| Choline | 0.5 | 8.0a | 7.4a | 6.8a | 6.9a | 6.9a |
| | | Photochemical Efficiency (Fᵥ/F^{m}) | | | | |
| Control | 0 | 0.724a | 0.656a | 0.638a | 0.585b | 0.566b |
| Choline | 0.125 | 0.726a | 0.659a | 0.668a | 0.611ab | 0.596ab |
| Choline | 0.25 | 0.726a | 0.672a | 0.645a | 0.648a | 0.615a |
| Choline | 0.5 | 0.718a | 0.690a | 0.661a | 0.659a | 0.610a |

Leaf chlorophyll and carotenoids. Choline application at 0.25 oz./1,000 ft² increased leaf chlorophyll content on day 14, 28, and 56. Choline application at 0.5 oz/1000 ft² increased leaf chlorophyll content on day 42 and 56. (Table 4.2). Choline applied at 0.25 oz./1,000 ft² increased carotenoids content at day 14, 28, and 56. Choline treatment at 0.5 oz./1,000 ft² increased carotenoids at day 56. Table 4.2 provides leaf chlorophyll and carotenoids responses to foliar application of choline in creeping bentgrass subjected to heat and drought stress.

TABLE 4.2
Leaf Chlorophyll and Carotenoids Responses to Foliar Application of Choline
in Creeping Bentgrass Turf Subjected to Heat and Drought Stress

| | Rate oz/ | -------------- days after treatment initiation -------------- | | | | |
|---|---|---|---|---|---|---|
| Treatment | 1000 ft² | 0 | 14 | 28 | 42 | 56 |
| | | Chlorophyll (mg/g Fresh Weight) | | | | |
| Control | 0 | 2.83a | 2.46bc | 2.22b | 1.71b | 1.55b |
| Choline | 0.125 | 3.04a | 2.40c | 2.16b | 1.74ab | 1.72ab |
| Choline | 0.25 | 2.95a | 2.76a | 2.75a | 2.10ab | 1.99a |
| Choline | 0.5 | 3.07a | 2.67ab | 2.54ab | 2.18a | 2.01a |
| | | Carotenoids (mg/g Fresh Weight) | | | | |
| Control | 0 | 0.98a | 0.91b | 0.80bc | 0.71a | 0.63b |
| Choline | 0.125 | 1.05a | 0.88b | 0.76c | 0.69a | 0.67b |
| Choline | 0.25 | 1.03a | 1.02a | 0.94a | 0.84a | 0.84a |
| Choline | 0.5 | 1.07a | 0.98ab | 0.91ab | 0.84a | 0.83a |

Leaf SOD activity and proline content. Super Oxide Dismutases are important antioxidant enzymes in plant defense systems against stress-induced oxidative injury through scavenging toxic free radicals. Choline application at 0.25 and 0.5 oz./1,000 ft² consistently improved SOD activity from day 28 through day 56 (Table 4.3). Table 4.3 provides leaf superoxide dismutase activity and proline content responses to foliar application of choline in creeping bentgrass subjected to heat and drought stress.

TABLE 4.3
Leaf Superoxide Dismutase (SOD) activity and Proline Content
Responses to Foliar Application of Choline in Creeping
Bentgrass Subjected to Heat and Drought Stress

| | Rate oz/ | -------------- days after treatment initiation -------------- | | | | |
|---|---|---|---|---|---|---|
| Treatment | 1000 ft² | 0 | 14 | 28 | 42 | 56 |
| | | SOD activity (Unit/g FW) | | | | |
| Control | 0 | 889.9a | 903.0a | 803.4b | 688.0c | 655.0c |
| Choline | 0.125 | 909.7a | 906.4a | 865.7ab | 752.3bc | 721.2bc |
| Choline | 0.25 | 870.8a | 930.7a | 885.1a | 872.3a | 866.5a |
| Choline | 0.5 | 878.3a | 911.1a | 900.7a | 836.4ab | 815.7ab |
| | | Proline content (μg/g FW) | | | | |
| Control | 0 | 57.4a | 166.1a | 138.5b | 128.7b | 112.9b |
| Choline | 0.125 | 64.1a | 170.7a | 156.5a | 156.1ab | 139.7b |
| Choline | 0.25 | 63.1a | 177.4a | 162.3a | 169.5a | 267.1a |
| Choline | 0.5 | 53.5a | 180.0a | 167.1a | 171.8a | 278.0a |

Proline is an osmoprotectant molecule that accumulates in many organisms in response to drought and salinity stress. Proline accumulation in plants can stabilize cell macromolecules and protect cells against oxidative stress. It was found that choline application at 0.25 and 0.5 oz./1,000 ft² increased proline content in leaf tissues as measured at day 28, 42, and 56 (Table 4.3).

Root biomass, growth characteristics, and viability. Foliar application of choline at all three rates increased root biomass (Table 4.4). Application of choline at 0.25 and 0.5 oz./1,000 ft² increased root length, surface area, volume, and root viability, relative to the control, but did not impact root diameter. The low rate of choline treatment did not affect root growth characteristics and viability. Table 4.4 provides root biomass, length, surface area (SA), diameter, volume, and viability responses to foliar application of choline in creeping bentgrass subjected to heat and drought stress.

TABLE 4.4
Root Biomass, Length, Surface Area, Diameter, Volume, and
Viability Responses to Foliar Application of Choline in
Creeping Bentgrass Subjected to Heat and Drought Stress.

| | Rate | Biomass | Length | Surface Area |
|---|---|---|---|---|
| Treatment | (oz/1000 ft²) | (g/pot) | (cm/cm³) | (cm²/cm³) |
| Control | 0 | 1.246b | 15.6b | 0.80b |
| Choline | 0.125 | 1.269a | 17.7ab | 0.90ab |
| Choline | 0.25 | 1.273a | 18.4a | 0.98a |
| Choline | 0.5 | 1.270a | 18.8a | 0.99a |
| | | Diameter | Volume | Viability |
| | | (mm) | (cm³/dm³) | (A490/g FW) |
| Control | 0 | 0.165ab | 3.29b | 0.57b |
| Choline | 0.125 | 0.161b | 3.61ab | 0.78ab |
| Choline | 0.25 | 0.170ab | 4.18a | 1.28a |
| Choline | 0.5 | 0.176a | 4.15a | 1.10a |

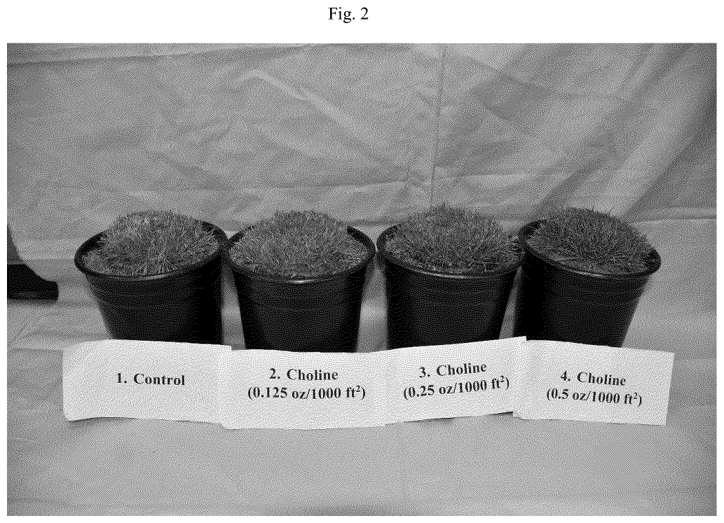

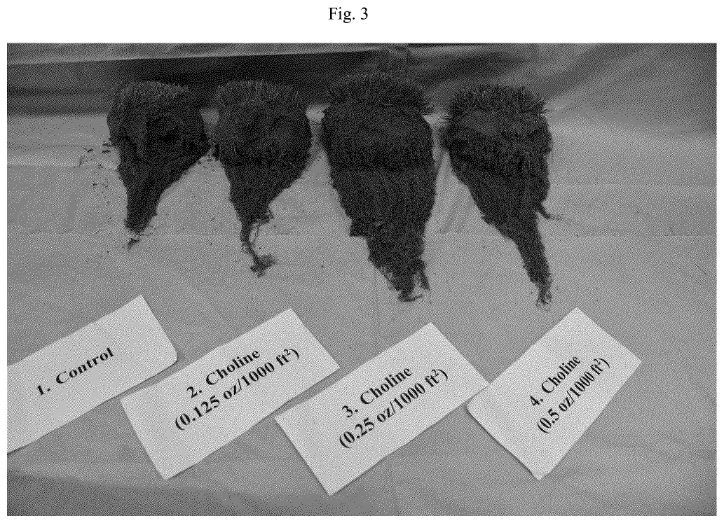

Photographs taken at the end of the trial are shown in FIGS. 2 and 3. As shown in FIG. 2, foliar application of choline at 0.25 and 0.5 oz./1,000 ft² improved leaf color ratings. As shown in FIG. 3, application of choline at 0.25 and 0.5 oz./1,000 ft² increased root length, surface area, volume, and root viability, relative to the control.

In summary, foliar application of choline chloride at 0.25 and 0.5 oz./1,000 ft² improved leaf color, chlorophyll, carotenoids, antioxidant SOD activity, proline content, root growth and viability in creeping bentgrass under heat and drought stress conditions.

### Experiment No. 5

As previously discussed, adding wetting agents can reduce the surface tension of water and water repellency, allowing the wetting agents to enter a hydrophobic soil medium and thereby facilitate water infiltration. However, due to the variation in soil and turf, especially the thatch layer, soil moisture status may vary in different spots/areas of putting greens even after wetting agent applications, resulting in dry spots and decline in turf quality and uniformity, especially during summer stress. Turfgrass may improve plant-water relation and drought tolerance through osmotic adjustment. Choline is an important compound associated with osmotic adjustment as the biochemical precursor of glycine betaine which is an important osmoprotectant. Prior experiments showed that choline applied at 0.25 oz./1,000 ft² provided similar beneficial effects on bentgrass quality and root growth when compared to choline applied at 0.5 oz./1,000 ft². The objective of this study was to evaluate the effects of Fleet® 100 applied at 5 Fl oz/1000 ft² and choline applied at 0.25 oz/1000 ft² alone or in combination on turf quality, physiological fitness, and root growth, as well as water absorption and retention, in creeping bentgrass putting greens during summer stress.

### Materials and Methods

The study was carried out on a creeping bentgrass putting greens at Virginia Tech Turfgrass Research Center in Blacksburg, VA. There were 4 treatments with 4 replications. Plot size was 5×6 ft. Regular mowing and irrigation were performed. A randomized block design was used. Fleet® 100 was supplied by Harrell's, LLC (Lakeland, FL) and choline from Sigma-Aldrich, Inc. (St. Louis, MO) were used in this study.

The treatments were as follows:
1. Fertilized Control (0.15 lb. Nitrogen (N) per 1,000 ft² every 14 days from 28-8-18 with UMAXX® fertilizer (Harrell's LLC, Lakeland, Florida)
2. Fleet® 100 at 5 oz./1,000 ft²/month+0.15 lb. N/1,000 ft² biweekly
3. Choline 0.25 oz./1,000 ft²/month+0.15 lb. N/1,000 ft² biweekly
4. Choline 0.25 oz./1,000 ft²/month+Fleet100 at 5 oz./1,000 ft²/month+0.15 lb. N/1,000 ft² biweekly
   The rate and source of fertilization for treatments #2, 3, and 4 was the same as treatment #1 (fertilized control), applied the day following application of all treatments. Between 0.125″ and 0.25″ of irrigation was applied after application and controlled to not cause puddling.

The trial lasted for 12 weeks and a total of 3 treatment applications. The following measurements took place on day 0, 14, 28, 42, 56, 70, and 84 after initial treatments (additional measurements on photochemical efficiency and VWC took place during 2 dry-down cycles (days 13-22; days 33-42):
a. Visual leaf color was rated on a 1-9 scale, with 1 indicating brown color and 9 indicating dark green color.
b. Turf quality was rated on a visual scale of 1-9 with 9 indicating optimal quality and 6 being minimum commercially acceptable quality.
c. Photochemical efficiency was measured with chlorophyll fluorometer (OS-50II, Opti-Sciences, Inc., Hudson, NH). Three readings were collected from each pot and the average was used for statistical analysis.
d. Leaf chlorophyll content. Leaf samples were collected biweekly and chlorophyll content was determined using the spectrophotometer method described by Zhang et al. (2005).
e. Volumetric water content. Volumetric water content was measured with a TDR350 moisture sensor (Turf-Tec Intentional, Tallahassee, FL) every 2 weeks. As previously stated, irrigation was withheld for about 9 days to allow gradual decline of the soil water content, inducing significant decline in leaf color and turf quality. Additional volumetric water content measurements were recorded on days 14, 17, 20, 22, 32, 35, 38, and 42 to coincide with dry down cycles. At day 9 of the dry down cycles, leaf samples were collected and leaf proline content was analyzed. Irrigation was resumed after day 9 of each dry down cycle. Three VWC readings were collected from each plot, and the average was used for statistical analysis.
f. Leaf proline content. Leaf samples were collected at the end of each dry down cycle and proline content was measured by using the method described by Wu et al. (2017).
g. Root characteristics, biomass, and viability. At the end of the trial, 4 root samples (1.9 cm diameter and 6 inch deep) were collected from each plot, washed and root dry weight was determined after the samples were dried at 70° C. for 72 h. The root length, root diameter, root surface area, and root volume were analyzed using WinRHIZO technology. Briefly, after fine cleaning of each root sample, the sample from each plot was divided into multiple subsamples. Each subsample was scanned using WinRHIZO and all root morphological parameters were generated and analyzed. In addition, root viability was analyzed using TTC method (Zhang et al., 2017). Root viability is a good indicator of root function.

### Results and Discussion

Turf quality. Foliar application of Fleet® 100 and choline alone or in combination improved turf quality beginning 22 days after initial application through the end of the trial (Table 5.1). For brevity, Fleet® 100 is referred to alternatively as “Fleet” or “Fleet100” herein. Fleet100+Choline had greater turf quality rating relative to Choline alone (4 measurement dates) or Fleet100 alone (5 measurement dates). Table 5.1 provides turf quality response to Fleet100 and Choline in creeping bentgrass putting greens.

TABLE 5.1
Creeping Bentgrass Putting Green Turf Quality
Response to Fleet100 and Choline

| | | | Turf quality (1-9, 9 = best) | | | |
|---|---|---|---|---|---|---|
| | | | days after treatment initiation | | | |
| Treatment | Rate/1000 ft² | | 0 | 14 | 22 | 28 |
| Control | — | | 7.5a | 7.0a | 6.3c | 7.3c |
| Fleet100 | 5 | fl oz | 7.5a | 7.4a | 6.7b | 7.6b |
| Choline | 0.25 | oz | 7.5a | 7.4a | 6.8ab | 7.6b |
| Fleet100 + Choline | 5 fl oz + 0.25 oz | | 7.5a | 7.4a | 7.0a | 8.0a |
| | | | days after treatment initiation | | | |
| | | | 42 | 56 | 70 | 84 |
| Control | — | | 6.2c | 7.0c | 6.6c | 6.9c |
| Fleet100 | 5 | fl oz | 6.6ab | 7.3b | 7.1b | 7.3b |
| Choline | 0.25 | oz | 6.5b | 7.4b | 7.2ab | 7.3b |

| | | | | | |
|---|---|---|---|---|---|
| Fleet100 + Choline | 5 fl oz + 0.25 oz | 6.8a | 7.7a | 7.5a | 7.6a |

Leaf color. Fleet100+choline alone or in combination improved leaf color ratings relative to the control as measured on days 14 through 84, except for choline on day 14 and Fleet100 on day 56 (Table 5.2). Fleet100+choline had better leaf color rating than the Fleet100 treatment as measured on days 42, 56, 70, and 84. Table 5.2 provides leaf color response to Fleet100 and choline in creeping bentgrass putting greens.

TABLE 5.2
Creeping Bentgrass Putting Green Leaf
Color Response to Fleet100 and Choline

| | | | Leaf color (1-9, 9 = dark green) | | | |
|---|---|---|---|---|---|---|
| | | | days after treatment initiation | | | |
| Treatment | Rate/1000 ft² | | 0 | 14 | 22 | 28 |
| Control | — | | 7.5a | 7.4b | 6.9b | 7.5b |
| Fleet100 | 5 | fl oz | 7.5a | 7.8a | 7.3a | 7.8a |
| Choline | 0.25 | oz | 7.5a | 7.6ab | 7.4a | 7.8a |
| Fleet100 + Choline | 5 fl oz + 0.25 oz | | 7.5a | 7.8a | 7.5a | 8.0a |
| | | | days after treatment initiation | | | |
| | | | 42 | 56 | 70 | 84 |
| Control | — | | 6.6c | 7.3c | 6.9c | 7.1d |
| Fleet100 | 5 | fl oz | 6.8b | 7.5bc | 7.3b | 7.3c |
| Choline | 0.25 | oz | 6.9ab | 7.7ab | 7.4ab | 7.4b |

| | | | | | |
|---|---|---|---|---|---|
| Fleet100 + Choline | 5 fl oz + 0.25 oz | 7.0a | 7.8a | 7.5a | 7.7a |

Photochemical efficiency (PE). Application of Fleet100+choline consistently improved PE relative to the control as measured from days 22 through 84. Choline alone also improved PE relative to the control as measured on days 22 and 56 (Table 5.3). Table 5.3 provides turf photochemical efficiency (PE) response to Fleet100 and Choline in creeping bentgrass putting greens.

TABLE 5.3
Creeping Bentgrass Putting Green Photochemical
Efficiency Response to Fleet100 and Choline

| | | | Photochemical Efficiency (Fᵥ/Fₘ) | | | | |
|---|---|---|---|---|---|---|---|
| | Rate/ | | -------------- days after treatment initiation -------------- | | | | |
| Treatment | 1000 ft² | | 0 | 14 | 22 | 28 | 40 |
| Control | — | | 0.703a | 0.655a | 0.575b | 0.743b | 0.679a |
| Fleet100 | 5 | fl oz | 0.702a | 0.688a | 0.662a | 0.751a | 0.703a |
| Choline | 0.25 | oz | 0.720a | 0.696a | 0.664a | 0.761a | 0.714a |
| Fleet100 + Choline | 5 fl oz + 0.25 oz | | 0.704a | 0.706a | 0.660a | 0.759a | 0.727a |
| | | | -------------- days after treatment initiation -------------- | | | | |
| | | | 42 | 56 | 70 | 84 | |
| Control | — | | 0.538b | 0.651b | 0.663b | 0.677b | |
| Fleet100 | 5 | fl oz | 0.609ab | 0.706ab | 0.728ab | 0.726ab | |
| Choline | 0.25 | oz | 0.634a | 0.729a | 0.733ab | 0.733ab | |

| | | | | | |
|---|---|---|---|---|---|
| Fleet100 + Choline | 5 fl oz + 0.25 oz | 0.663a | 0.730a | 0.754a | 0.744a |

Leaf chlorophyll and proline. Fleet100 or choline alone or in combination increased leaf chlorophyll content when compared to the control as measured from day 28 through 84, except for Fleet100 alone on days 42, 56, and 84 (Table 5.5). As measured on day 70, Fleet100 plus choline had greater chlorophyll content than either Fleet100 or choline alone. Table 5.5 provides leaf chlorophyll content response to Fleet100 and choline in creeping bentgrass putting greens.

TABLE 5.5
Creeping Bentgrass Putting Green
Response to Fleet100 and Choline

| | | | Chlorophyll Content (mg/g fresh weight) | | | |
|---|---|---|---|---|---|---|
| | | | days after treatment initiation | | | |
| Treatment | Rate/1000 ft² | | 0 | 14 | 28 | 42 |
| Control | — | | 2.32a | 2.68a | 3.39b | 2.31b |
| Fleet100 | 5 | fl oz | 2.46a | 2.76a | 3.74a | 2.64ab |
| Choline | 0.25 | oz | 2.45a | 2.90a | 3.85a | 3.03a |

| | | | | | |
|---|---|---|---|---|---|
| Fleet100 + | 5 fl oz + 0.25 oz | 2.30a | 2.81a | 3.85a | 3.08a |
| Choline | | | | | |

| | | | days after treatment initiation | | |
|---|---|---|---|---|---|
| | | | 56 | 70 | 84 |
| Control | — | | 2.93b | 2.50c | 2.26b |
| Fleet100 | 5 | fl oz | 3.25ab | 2.78b | 2.48ab |
| Choline | 0.25 | oz | 3.46a | 2.79b | 2.57a |

| | | | | |
|---|---|---|---|---|
| Fleet100 + | 5 fl oz + 0.25 oz | 3.49a | 3.05a | 2.63a |
| Choline | | | | |

Application of choline alone or Fleet100+choline improved proline content compared to the control as measured at the end of 2^{nd} dry-down cycle, day 42 (Table 5.6). Table 5.6 provides leaf proline content response to Fleet100 and choline in creeping bentgrass putting greens.

TABLE 5.6
Creeping Bentgrass Leaf Proline Content
Response to Fleet100 and Choline

| | | | Proline (ug/g FW) | |
|---|---|---|---|---|
| | | | days after treatment initiation | |
| Treatment | Rate/1000 ft² | | 22 | 42 |
| Control | — | | 409.3a | 422.1b |
| Fleet100 | 5 | fl oz | 498.0a | 508.6ab |
| Choline | 0.25 | oz | 467.0a | 538.0a |

| | | | |
|---|---|---|---|
| Fleet100 + Choline | 5 fl oz + 0.25 oz | 475.9a | 544.7a |

Root biomass, rooting characteristics, and viability. Fleet100 and Fleet100+Choline increased root biomass relative to the control. Fleet100+Choline increased root surface area (SA) and root volume relative to the control. Fleet100 and Choline alone improved root viability (Table 5.7). Table 5.7 provides root biomass, root growth characteristics, and viability response to Fleet100 and Choline in creeping bentgrass putting green.

TABLE 5.7
Creeping Bentgrass Putting Green Root Biomass, Rooting Characteristics,
and Viability Response to Fleet100 and Choline

| | | | Biomass | Length | SA |
|---|---|---|---|---|---|
| Treatment | Rate/1000 ft² | | (mg/cm³) | (cm/cm³) | (cm²/cm³) |
| Control | — | | 1.76b | 94.9a | 5.72b |
| Fleet100 | 5 | fl oz | 2.41a | 127.7a | 7.71ab |
| Choline | 0.25 | oz | 2.14ab | 118.2a | 7.02ab |
| Fleet100 + | 5 fl oz + 0.25 oz | | 2.40a | 126.3a | 8.33a |
| Choline | | | | | |
| | | | Diameter | Volume | Viability |
| | | | (mm) | (cm³/dm³) | (A490/g FW) |
| Control | — | | 0.192ab | 27.6b | 0.36b |
| Fleet100 | 5 | fl oz | 0.185b | 37.2ab | 0.54a |
| Choline | 0.25 | oz | 0.187b | 33.4ab | 0.49a |

| | | | | |
|---|---|---|---|---|
| Fleet100 + | 5 fl oz + 0.25 oz | 0.211a | 43.9a | 0.46ab |
| Choline | | | | |

In summary, monthly application of Fleet100 at 5 oz/1,000 ft² and choline at 0.25 oz/1,000 ft² alone or in combination improved turf quality, leaf color ratings and chlorophyll content in creeping bentgrass putting greens. In general, the Fleet100+choline combination had greater beneficial effects on turf quality, leaf color and chlorophyll content than either Fleet100 or choline alone. The Fleet100 and choline combination increased leaf proline content, root biomass, surface area, and volume when compared to the control.

### ADDITIONAL DISCUSSION

A specific choline chloride dosage, as a component in a liquid soil treatment that reduces water repellency and promotes water infiltration and distribution, was identified that promotes plant health in a drought stress environment, such as is commonly encountered in creeping bentgrass putting greens and other ornamental turfgrass applications during summer months. Wetting agents such as Fleet® 100 can create dryer soil conditions by facilitating movement of excess water through the soil profile. The experiments above, for example, Experiment No. 3, showed that choline alone affected water penetration into the soil and that the amount of choline supplied was inversely proportional to the amount of time to water penetration. The application of choline to the soil caused the soil to retain water. High rates of choline, such as 0.5 oz./1,000 ft² conferred a substantial reduction in the amount of time to water penetration. Although choline has been known to improve plant physiology, its effect on water movement through the soil had not been significantly studied. The inclusion of choline in a known soil wetting agent unexpectedly complimented the action conferred by the wetting agent, as choline itself was found to increase water penetration. A choline dosage was identified through further study that conferred plant physiological benefits while also enhancing water penetration similar to traditional wetting agent chemistries such as Fleet 100. The wetting agent does not serve as a mere delivery system for choline. Given the unexpected effect of choline on water penetration, the amount of choline to improve physiological properties, such as leaf color, to combat occasional localized browning in a drought stress environment treated with a wetting agent, was lower than expected. Given the synergistic effect between the wetting agent and choline identified by the inventors, the combination of the two frequently performed better than either wetting agent or choline alone, as shown above in the studies, such as Experiment No. 5. As mentioned above, certain wetting agents promote water retention in the soil, thus mitigating drought stress response in turfgrass. In such applications, choline may be added to such wetting agents to obtain the desired plant physiological response.

The improved liquid soil treatments disclosed herein can be manufactured commercially. Choline is available commercially in various forms, including various salts, such as choline chloride and choline bitartrate. A substantially pure (e.g., 99% pure) crystalline form of choline can be dissolved in a suitable wetting agent. Mixing the choline into the wetting agent in a mixer can speed the dissolution and overall manufacturing process. The improved wetting agent formulations herein can be applied via calibrated spray equipment in conjunction with a diluting agent, as is known in the art, thus avoiding any requirement that users obtain new equipment to apply such formulations.

### OTHER EMBODIMENTS

It is to be understood that while the invention has been described in conjunction with the detailed description thereof, the foregoing description is intended to illustrate, and not limit the scope of the invention, which is defined by the scope of the appended claims. Other aspects, advantages, and modifications are within the scope of the following claims.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

1. A liquid soil treatment for improving plant quality consisting essentially of:
a soil wetting agent in a first amount;
choline in a second amount.

2. The liquid soil treatment of claim 1, wherein the choline is in a form selected from the group consisting of choline chloride and choline bitartrate.

3. The liquid soil treatment of claim 2, wherein the second amount of choline comprises 1.0-33.3% by weight of the liquid soil treatment.

4. The liquid soil treatment of claim 3, wherein the second amount of choline comprises 3.0-5.0% by weight of the liquid soil treatment.

5. The liquid soil treatment of claim 1, wherein the soil wetting agent is selected from the group consisting of polyoxyalkylene polymers, polyoxyethylene surfactants, humectants, alkylphenol ethoxylate surfactants, anionic surfactants, nonionic surfactants, straight block copolymer surfactants, reverse block copolymer surfactants, blends of straight and reverse block copolymers, alkyl polyglucoside surfactants, modified methyl capped block copolymers, humic substance redistribution molecules, multibranched regenerating wetting agents, and cationic surfactants.

6. The liquid soil treatment of claim 1, wherein the soil wetting agent comprises polyoxyalkylene polymers.

7. The liquid soil treatment of claim 6, wherein the first amount of the soil wetting agent comprises 95.0-97.0% by weight of the liquid soil treatment, and wherein second amount of choline comprises 3.0-5.0% by weight of the liquid soil treatment.

8. A treatment method for improving plant quality comprising:
applying a liquid soil treatment to soil containing plants, wherein the liquid soil treatment consists essentially of a soil wetting agent in a first amount, choline in a second amount, and an optional diluting agent in a third amount.

9. The treatment method of claim 8, wherein the choline is in a form selected from the group consisting of choline chloride and choline bitartrate.

10. The treatment method of claim 9, wherein the second amount of choline comprises 1.0-33.3% by weight of a total combined weight of the soil wetting agent and the choline.

11. The treatment method of claim 10, wherein the second amount of choline comprises 3.0-5.0% by weight of the total combined weight of the soil wetting agent and the choline.

12. The treatment method of claim 8, wherein the soil wetting agent is selected from the group consisting of polyoxyalkylene polymers, polyoxyethylene surfactants, humectants, alkylphenol ethoxylate surfactants, anionic surfactants, nonionic surfactants, straight block copolymer surfactants, reverse block copolymer surfactants, blends of straight and reverse block copolymers, alkyl polyglucoside surfactants, modified methyl capped block copolymers, humic substance redistribution molecules, multibranched regenerating wetting agents, and cationic surfactants.

13. The treatment method of claim 8, wherein the soil wetting agent comprises polyoxyalkylene polymers.

14. The treatment method of claim 13, wherein the first amount of the soil wetting agent comprises 95.0-97.0% by weight of a total combined weight of the soil wetting agent and the choline, and wherein second amount of choline comprises 3.0-5.0% by weight of the total combined weight of the soil wetting agent and the choline.
